(19) United States
(12) Patent Application Publication
(10) Pub. No.: US 2003/0128873 A1
(43) Pub. Date: Jul. 10, 2003

(54) Imaging system and method for generating a digital image file

(76) Inventor: Barry Bronson, Saratoga, CA (US)

Correspondence Address: HEWLETT-PACKARD COMPANY, Intellectual Property Administration, P.O. Box 272400, Fort Collins, CO, 80527-2400, US

(21) Appl. No.: 10/036,405

(22) Filed: Jan. 7, 2002

(51) Int. Cl. H04N 1/38; G06K 9/36; G06K 9/20; G06K 9/62; G06T 7/00

(52) U.S. Cl. 382/163; 382/218; 382/319; 382/282

(57) ABSTRACT

An imaging system includes a cover having an underside with an identifiable pattern disposed over a platen. The imaging system is capable of recognizing the identifiable pattern and removing data from a digital image file of the scanned original corresponding to portions containing the identifiable pattern. An alternative imaging system provides for a preliminary scan that locates extraneous objects in the background of a scanned region. When an original is scanned, the digital image file from the scan of the original can be compared with the preliminary scan to remove extraneous images from the digital image file.

### TECHNICAL FIELD

The technical field is generating clean copies in imaging systems. More specifically, the technical field is generating digital image files of originals in which extraneous images in a region scanned by an imaging device are excluded from a digital image file of the scanned original.

### BACKGROUND

In copier and scanner devices, a cover or other element used as a background during a scan process may include scratches, marks, and other imperfections. In addition, rollers used to advance sheets of originals through a device, as well as other parts of the device, may also appear in the background. If an original is smaller than a region scanned by the device, the imperfections and/or elements are scanned by the device and are included as part of the digital image file resulting from the scan.

The imperfections in the background imagery of copier and scanner devices, along with images of parts of the devices, are undesirable because they detract from the image of the original. If the digital image file is used to make copies, the extraneous images of the imperfections and parts of the devices will appear in the copies. If the device is a scanner, the extraneous images add to the size of the digital file resulting from the scan as well as detracting from the image scan of the original.

One approach to the above problem is to place white paper behind the original before scanning. The white paper serves as a background for the scan process. This approach is undesirable, however, because of the added time and effort required to scan originals. In addition, the paper itself may include imperfections, which will appear in the digital image file resulting from the scan.

### SUMMARY

According to a first aspect, an imaging system comprises a platen, an imager disposed to detect an image of an original in a scanned region of the platen, and a cover, wherein an underside of the cover includes an identifiable pattern disposed over the platen. A processor can be included to process a scanned digital image of the original from the imager, and to remove data from regions of the digital image corresponding to the identifiable pattern from a digital image file of the scanned original. The processor can be included as part of the imager, or located in another part of the imaging system.

According to the first aspect, the portions of the digital file of the scanned image containing the identifiable pattern can be removed, or, filled with “null data” early in the processing of the digital image. This feature reduces the amount of data processed during operation of the imaging system. The resulting digital image file therefore includes an image of the original surrounded by a border without extraneous images.

Also according to the first aspect, the use of the identifiable pattern allows the processor to locate the original in the scanned region. Resizing of the image of the original can therefore be performed automatically. In addition, it is unnecessary to orient the original on a particular part of the platen before scanning.

According to a second aspect, an imaging system comprises a platen, an imager disposed in the imaging system to detect an image of an original in a scanned region of the platen, a cover, and a processor. The imaging system is capable of performing a preliminary scan without an original present in the scanned region in order to locate extraneous images in the scanned region. The processor then compares the image data from the preliminary scan with the scanned digital image of the original. Based on this comparison, the extraneous images from the preliminary scan can be removed from the digital image file of the original.

According to the second aspect, extraneous images that would otherwise detract from the digital image of the original can be excluded from a scanned image of the original.

According to a third aspect, a method of generating a digital image file comprises scanning a scanned region while an original is located in the scanned region, detecting a at least one of a background color or a background pattern of the original, generating a digital image file from the scan, and filling in a region of the digital image file with the background color or pattern of the original.

According to the third aspect, a relatively small colored or patterned original can be used to generate “full size” copies in which the full size copies include a color background or pattern that has the same color or pattern as the original. If the digital image file is to be stored or forwarded, the digital image file could be viewed as a full size image with a colored or patterned background, rather than as a relatively small region of color or pattern surround by a white border. A scan of an original having both a color and a patterned background can be scanned so that both the background color and pattern are included in the resultant digital image file.

According to a variant of the third aspect, a background color or pattern can be removed from the digital image file. The variant reduces the size of the resultant digital image file and removes image data that may be unnecessary or undesirable.

Other aspects and advantages will become apparent from the following detailed description, taken in conjunction with the accompanying figures.

### BRIEF DESCRIPTION OF THE FIGURES

The detailed description will refer to the following figures wherein like reference numerals refer to like elements and wherein:

FIG. 1 is a schematic view of a portion of an imaging system suitable for use in embodiments of the present invention;

FIG. 2 is a plan view of an original superposed over a scanned region;

FIG. 3 is a plan view of the underside of a cover having an identifiable pattern according to a first embodiment;

FIG. 4 is a plan view of the underside of an alternative cover having an identifiable pattern;

FIG. 5 is a plan view of the underside of another alternative cover having an identifiable pattern;

FIG. 6 is a plan view of a roller including the identifiable pattern illustrated in FIG. 3;

FIG. 7A is a plan view of a scanned region according to a second embodiment;

FIG. 7B is a plan view of the scanned region illustrated in FIG. 7A with an original in the scanned region;

FIG. 8 is a flow chart illustrating a method of generating digital image files according to the second embodiment; and

FIG. 9 is a flow chart illustrating of method of generating digital image files according to a third embodiment.

### DETAILED DESCRIPTION

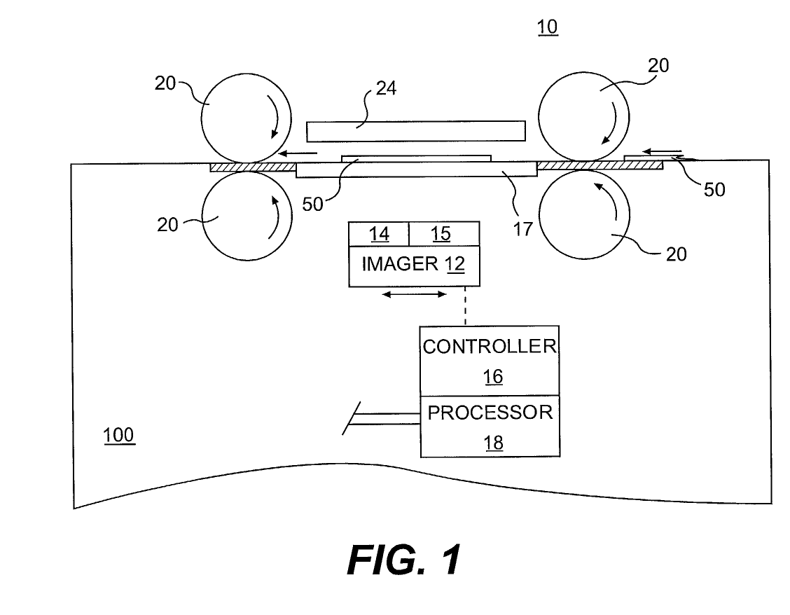

FIG. 1 is a schematic view of an imaging system 10. The imaging system 10 includes an imager 12 coupled to a controller 16. The imager 12 can include an illumination system 14 and an image sensor 15 for sensing an image reflected off of originals 50 during a scanning process. The imager 12 performs a scan of the originals 50 as they pass over a transparent platen 17, and the scan is used to create digital image files of the originals 50. A processor 18 can be included as part of the controller 16, or the processor 18 can be located in another part of the imaging system 10, such as, for example, in the imager 12. Alternatively, the imager 12 could include an integral processor capable of creating a digital image file.

The imaging system 10 includes a chassis 100 for housing system components. The imaging system 10 embodiment illustrated in FIG. 1 can operate as a copier, as a scanner, or, as both a copier and a scanner. The imaging system 10 can therefore have the ability to, for example, use a digital image file from a scan of an original to produce a copy of the original, to save a digital image file of the original on digital media, or to forward a digital image file to another electronic device, such as a personal computer.

For the purposes of this specification, an “original” can include any relatively thin object having a side which can be scanned by the imager 12. Examples of originals include, for example, paper sheets, plastic sheets, and other printable media. An original can also include an object such as, for example, a book, which can be placed manually over the platen 17.

A positioning system (not illustrated) can translate the imager 12 in the direction of the two-headed arrow to scan an original 50. Alternatively, the imager 12 can scan originals 50 without translation. For the purposes of this specification, a “scan” can include any known process where light reflected from an original 50 is detected by the imager 12 for conversion to digital format. The image sensor 15 can include, for example, an array of known sensors for detecting light reflected from an original 50, and for converting the light signals to digital format by methods such as a digital capture process using a photonic conversion process. The image sensor 15 can include, for example, a linear charge-coupled device (CCD) array used in a scan process involving translation. Alternatively, the image sensor 15 can include, for example, a two-dimensional CCD array of sufficient size so that translation of the imager 12 is not necessary to capture the entire original 50.

In the embodiment illustrated in FIG. 1, rollers 20 advance originals 50 across the platen 17 to enable scanning of the originals 50 in rapid succession. The embodiments in this specification are not limited to an imaging system having a feed mechanism, however, and an imaging system operating by, for example, manual feeding of originals, could also employ the features described in the embodiments.

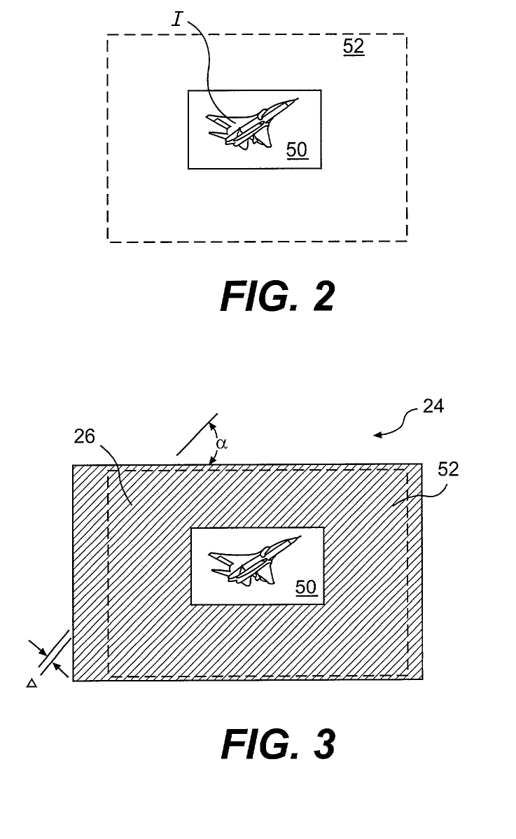

A cover 24 serves as a background for the scanning operation performed by the imager 12. If an original 50 is relatively small compared to the region scanned by the imager 12, the cover 24 serves as a background for the area of the scanned region around or adjacent to the original 50. This feature is illustrated by FIGS. 2 and 3.

FIG. 2 is a plan view of an original 50 passing over the platen 17 illustrated in FIG. 1, as detected by the imager 12. The original 50 includes an image I. Only the original 50 and a scanned region 52 are illustrated in FIG. 2. As shown in FIG. 2, the region 52 scanned by the imager 12 may be larger than the original 50. The scanned region 52 of the platen 17 can be defined by default settings of the imaging system 10, and can be changed according to the desired use.

The cover 24 (illustrated in FIG. 1) serves as the background for the portion of the scanned region 52 adjacent to the original 50. In known copiers and scanners, covers or other devices used as a background may include scratches, marks, and other imperfections. In addition, rollers used to advance originals through the copier or scanner can appear in the scanned image if an original is smaller than a scanned region. These imperfections and elements appear as a part of the digital image files generated by known copiers and scanners. The imperfections and/or elements of a copier or scanner device can be any object, scratch, mark, or other artifact that is recognized by the device but that is not desired to be a part of the digital image. The images resulting from the imperfections and/or elements can be referred to generally as “extraneous images.”

According to the first embodiment, the underside of the cover 24 includes an identifiable pattern that may be detected by the imager 12. The imaging system 10 uses the identifiable pattern to ensure that extraneous images do not appear in digital image files generated by the imaging system 10. An example of an identifiable pattern 26 is illustrated in FIG. 3. The identifiable pattern 26 is disposed on an underside of the cover 24. The identifiable pattern 26 is illustrated along with an original 50 being scanned, as perceived by the imager 12 during scanning. In the illustrated embodiment, the identifiable pattern 26 includes lines spaced at a predetermined distance Δ and oriented at a predetermined angle a. During scanning, the imager 12 detects an image of the scanned region 52. The scanned region 52 includes both the original 50 and a portion of the identifiable pattern 26 around or adjacent to edges of the original 50.

The imager 12 converts the image in the scanned region 52 to digital format. The processor 18 recognizes the identifiable pattern 26 adjacent to the original 50, and processes the digital image data accordingly. The processor 18 can process the digital image data from the scan of the original 50 by removing, or, in other words, filling with “null data” those portions of the scanned region 52 including the identifiable pattern 26. Null data can be defined generally as data resulting in “white space” or “blank space” in the digital image file. If the imaging system is used as a copier, the “white space” can be described as a “no print” region for copies.

Filling in the portion of the digital image file corresponding to the identifiable pattern 26 with null data ensures that any extraneous images lying in the area of the identifiable pattern 26 are removed from the resultant digital image file. The processor 18 can detect the presence of the identifiable pattern 26 in the digital image from the scan by, for example, a pattern matching algorithm. The processor 18 can include, for example, stored information describing the identifiable pattern 26. The stored information can be entered in the imaging system 10, for example, during manufacture of the imaging system 10. After processing, the processed digital image file contains the image of the original 50, and a “clean” border around or adjacent to the image of the original 50. The processed digital image file can thereafter be used for, for example, making copies of the original 50, storage on a digital storage media, or forwarding to another electronic device, such as a personal computer.

The processor 18 can also process the digital image data to scale up the image of the original 50 to fill a desired image size. For example, if the original 50 is a relatively small sheet, such as a personal check, the portion of the scanned region 52 including the identifiable pattern 26 is relatively large. The processor 18 can identify the edges of the original 50 by virtue of the ability of the processor 18 to recognize the parts of the digital image data including the identifiable pattern 26. The processor 18 can then automatically resize the digital image file of the original to fill an area comparable to the size of the scanned region 52, or to any other desired size. The resize feature can be included in, for example, a menu of copy or scan features on the imaging system 10.

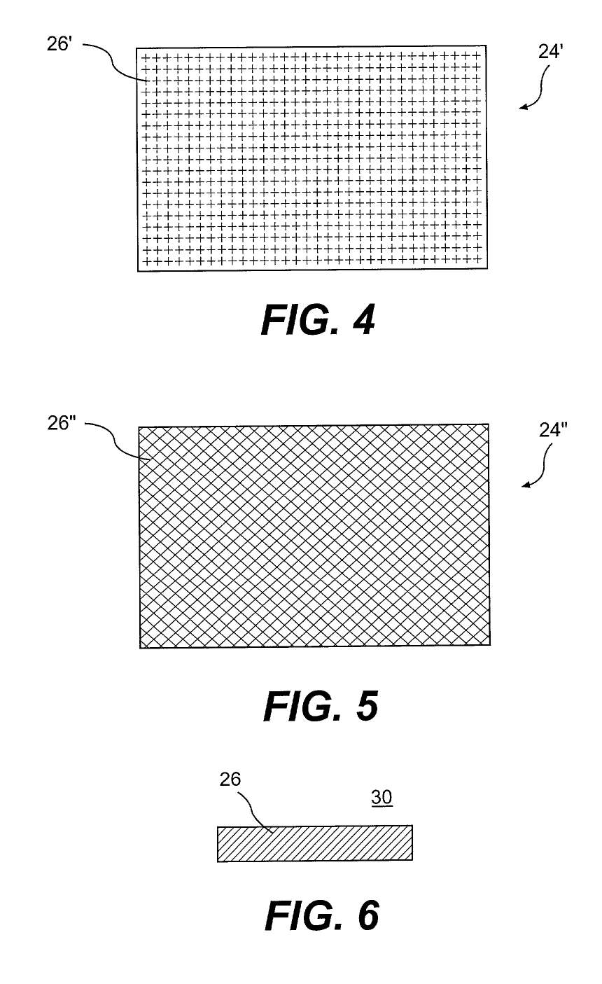

FIG. 4 is a plan view of the underside of an alternative embodiment of a cover 24′ having an identifiable pattern 26′. FIG. 5 is a plan view of the underside of yet another alternative embodiment of a cover 24″ having an identifiable pattern 26″. The identifiable patterns 26, 26′, 26″ discussed above are merely exemplary, and any identifiable markings that are discernable during a scanning or an image processing operation are appropriate. Preferably, the identifiable patterns 26, 26′, 26″ include patterns that are not normally found in originals.

In an alternative embodiment, additional elements that may be within the scanned region 52 can include an identifiable pattern. As an example, FIG. 6 illustrates a plan view of a roller 30 including the identifiable pattern 26. According to the above embodiments, any object that may appear in the scanned region 52 can include an identifiable pattern so that an image of the object can be removed during processing.

In addition to applying an identifiable pattern to certain regions of a background for a scan process, information about known objects in the background can be stored in the imaging system 10 prior to scanning. For example, the shape, size and colors of rollers in an imaging system are known at the time of assembly. The processor 18 can therefore be programmed to remove image data gathered in a scan that corresponds to rollers or other known objects.

According to the above embodiments, the portions of the digital file of the scanned image containing the identifiable patterns 26, 26′, 26″ can be filled with null data early in the processing of the digital image. This feature reduces the amount of data processed during operation of the imaging system 10. The resulting digital image file therefore includes an image of the original 50 surrounded by a border without extraneous images. Also according to the above embodiments, resizing can be performed automatically by the imaging system 10, without the necessity of orienting the original 50 on a particular part of the platen 17 before scanning.

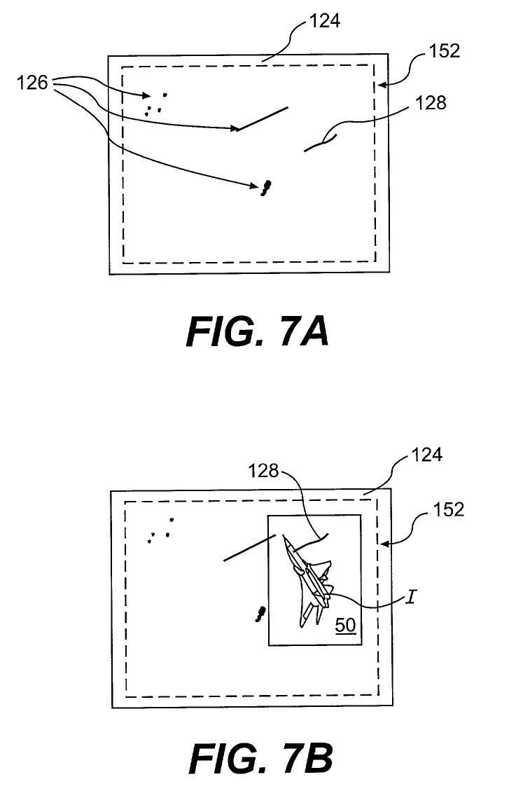

FIGS. 7A and 7B illustrate a second embodiment. FIG. 7A is a plan view of a scanned region 152 according to the second embodiment. The second embodiment may be used in an imaging system 10 as illustrated in FIG. 1. According to the second embodiment illustrated by FIGS. 7A and 7B, the imaging system 10 includes an alternative cover 124. The cover 124 does not require an identifiable pattern on its underside.

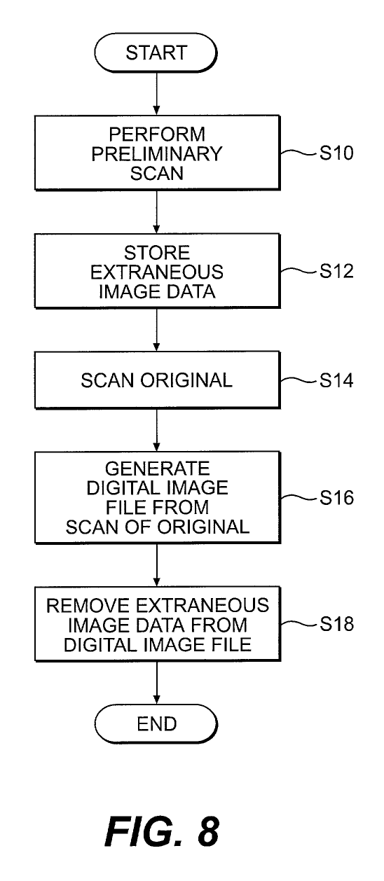

In the imaging system 10, imperfections 126 in the platen 17, in the cover 124, and the presence of rollers used to advance originals 50 through the imaging system 10 may all affect the images scanned by the imager 12. Another imperfection 128 intersects the image I on the original 50. According to the second embodiment, a method for scanning an original 50 includes a preliminary scan by the imager 12 to detect extraneous images in the scanned region 152. The method according to the second embodiment is illustrated in FIG. 8.

Referring to FIG. 8, in step S10, the imager 12 performs a preliminary scan of the scanned region 152 and detects extraneous images in the scanned region 152 prior to scanning originals 50. The extraneous images in the scanned region 152 can be any object, scratch, mark, or other artifact that is detected by the imager 12 but that is not desired to be a part of the digital image of a scanned original. The preliminary scan of the scanned region 152 therefore detects extraneous images that may appear when originals are scanned.

In step S12, the processor 18 stores the digital image data of the extraneous images. The extraneous digital image data can be stored as, for example, a digital template.

In step S14, an original 50 is scanned. Referring to FIG. 7B, when a copy of an original 50 is to be made, the original 50 may be placed manually over the platen 17, or advanced across the platen 17 by the rollers 20. The imager 12 scans the scanned region 152, including the image of the original 50, and any imperfections in the platen 17, the cover 124, and additionally the image of any imaging system elements such as rollers. In step S16, a digital image file is generated from the scan of the original 50.

In step S18, the imager 12 processes the scanned image to remove extraneous image data from the digital image file of the original. The imager 12 can remove the extraneous image data by comparing the stored image data of the extraneous images with the digital image file generated in step S16. Image data from the digital image file of the original scan that matches the extraneous image data from the preliminary scan is then removed from the digital image file. The digital template containing extraneous image data can be compared to the scan of the original by, for example, executing a pattern matching algorithm.

If an extraneous image intersects a portion of the original 50, the processor 18 can process the extraneous image data differently than if the extraneous image were outside of the edges of the original 50. The edges of the original 50 can be detected, for example, using a cover having a patterned underside, such as in the embodiments discussed with respect to FIGS. 2-6. Because the locations of the extraneous images are known from the preliminary scan, when the processor 18 determines the edges of the original, the extraneous images can be automatically removed from the digital image file of the original 50. However, if an extraneous image intersects with a portion of an image I, removing the extraneous image may remove a portion of the image I. To reduce negative effects of processing the scanned image, the processor 18 can instead reduce an intensity of extraneous image data by a predetermined percentage when an extraneous image intersects the image I.

As another alternative method for removing extraneous image data, the processor 18 can remove extraneous image data adjacent to or intersecting the image I while retaining image data from the image I. The processor 18 can retain image data from the image I by examining image data from the scan of the original 50 that are adjacent to the extraneous images and maintaining continuities in the image I when removing the extraneous images. This embodiment is illustrated by FIG. 7B, where the extraneous image 128 intersects a line of the image I. The processor 18 can detect that the extraneous image 128 intersects a line or another part of the image I because it knows the location of the extraneous image 128 from the preliminary scan. Any image data adjacent to or intersecting the extraneous image 128 is therefore attributable to the image I. The shape and line thickness of continuous regions of the image I can also be used to distinguish the image I from the extraneous image 128. During removal of the extraneous image 128 intersecting the image I, the processor 18 can maintain the continuity of the image I by extrapolating the continuous parts of the image I where the extraneous image 128 is removed during processing. If the image I on the original is a known font of text, the processor 18 can include stored information regarding known fonts and can preclude removal of image data that would create a discontinuity in the text. According to this embodiment, if the imaging system 10 is capable of color scanning, color differences between extraneous images and the image I can be used to distinguish a scanned image I from extraneous images.

The processor 18 can also reconstruct parts of an image I crossing an extraneous image I by recognizing patterns that repeat in an image I during scanning. For example, if the original 50 includes a particular font of text, the processor 18 can recognize the font and store each of the characters of the font in a table. The original 50 should be sampled for patterns that occur in multiple locations of the original 50, in a region outside of the known locations of extraneous images. If a part of the image I matching one of the stored patterns crosses one of the known extraneous images, the part of the image I removed during removal of the extraneous image can be restored according to the pattern stored in the table. If the part of the image I crossed by the extraneous image does not correspond to one of the stored patterns, the part of the region I removed during removal of an extraneous image can be restored by interpolation, as discussed above.

The imaging system 10 performs preliminary scans at any time during operation of the imaging system 10. For example, the controller 16 can order a preliminary scan upon power-up of the imaging system 10. Alternatively, preliminary scans can be performed at regularly timed intervals. Preliminary scans could also be initiated more frequently during periods of heavy use of the imaging system 10.

The preliminary scans of the scanned region 152 can also be used to alert users of the imaging system 10 that the imaging system should be cleaned or that maintenance of the imaging system 10 is required. For example, if the platen 17 contains excessive smudges or other particulate matter, the preliminary scan of the scanned region 152 would contain a large amount of data in the digital template of extraneous images. Scratches on the platen 17 would also increase the size of the digital template. The processor 18 detects the size of the digital template and provides a message to users that the imaging system 10 requires cleaning and/or maintenance. Image data in the digital template attributable to parts of the imaging system 10, such as rollers, would not be used to determine whether the size of the digital template is too large.

If the imaging system 10 contains many imperfections, as may occur in an older device, the threshold level for image data in the digital template can be increased. This prevents unnecessary indications of required maintenance in an older imaging system 10 that may contain imperfections that are not easily corrected. One method for increasing the threshold level is by performing a scan after cleaning and/or maintenance of the imaging system 10, and setting the baseline level for extraneous image data by that scan. The maintenance and/or cleaning message can thereafter be triggered by an increase of extraneous image data over the baseline level by a predetermined threshold value.

The preliminary scan can be performed in two stages so that imperfections of the platen 17 can be differentiated from imperfections or objects behind the platen 17. A first preliminary scan can be performed with nothing on the platen 17, and an image of extraneous images on the platen 17 and behind the platen 17 can be obtained. A second scan of the platen 17 only is then obtained by placing a white opaque sheet over the platen 17. The two preliminary scans can be compared to determine which extraneous images are due to imperfections on or in the platen 17. The classification of extraneous images as located on or in the platen 17 is useful because when an original 50 is sufficiently large, so as to cover a scanned region, only imperfections in the platen will result in extraneous image data in the scanned image. The processor 18 can therefore use two separate digital templates to remove extraneous images from a digital image file.

As an alternative to using an opaque white sheet of paper, the processor 18 can detect the presence of image data that is always present when performing scans, where the originals 50 fully occupy the scanned region. These image data correspond to imperfections in the platen 17.

According to the above embodiment, extraneous images that would otherwise negatively affect a digital image of an original 50 can be recognized and removed from a digital image file of the original 50.

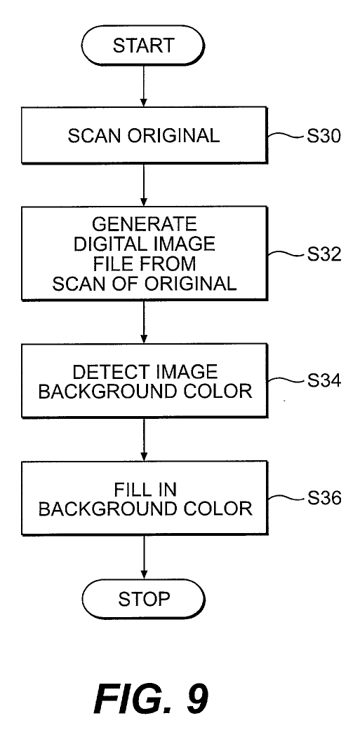

FIG. 9 illustrates a method of generating a digital image file according to a third embodiment. In the third embodiment, the imaging system 10 can recognize a color of an original 50 and can fill in a digital image file with the color of the original 50. This embodiment is particularly useful when a relatively small original comprising colored paper, such as, for example, a yellow note paper, is scanned. A conventional scanner with color capability would scan the small color original, and the resultant digital image file would include a color region surrounded by white (from the cover). According to the third embodiment, the imaging system 10 can recognize the existence of a color original 50 and can generate a digital image file in which the background or border around the original 50 is filled with the color of the original 50, rather than with white. The digital image file can thereafter be stored, or can be used to produce a full-size copy having a background color of the original 50. The method according to the third embodiment is discussed in detail below.

In step S30, the original 50 is scanned. In step S32, a digital image file is generated from the scan of the original 50. In step S34, the background color of the original 50 is detected. The background color can be detected during processing of the scanned image in the processor 18. The background color can be detected by a number of methods. A first method of detecting background color includes detecting a color that is particularly prevalent in a scanned region. For example, if the color yellow occupied greater than a predetermined percentage of the scanned region, the processor 18 could use the most prevalent, or “dominant” color as the background color for the digital image file generated by the processor 18.

Alternatively, if the processor 18 recognizes the edges of the original 50, the dominant color could be detected for the original 50, and this color adopted as the background color for the entire digital image file. The edges of the original could be detected, for example, using an imaging system having a cover with a patterned underside, such as in the embodiments discussed above with reference to FIGS. 2-6. If there is no clear dominant color within the original, the color around the edges of the original 50 could be detected and that color can be assigned as the dominant color of the original 50.

In step S36, the background color adopted by the processor 18 is used to fill in a background for the digital image file of the scanned original 50. If the imaging system 10 is functioning as a copier, copies generated by the imaging system 10 will have a background color corresponding to the original 50. As an alternative to filling a background color corresponding to the color of the original 50, the processor 18 could replace the background color of the original 50 with “white” or “no print” for copies made from the scan of the original 50, yet retain the color information of all color markings that differ from the background color. This feature may be particularly useful when the imaging system 10 is capable of color copying, but a color background is not desired for copies of the original.

According to the third embodiment, a relatively small original 50, such as a 3″×5″ yellow note pad, can be used to generate copies on, for example, 8.5″×11″ or 8.5″×14″ paper (e.g., “full size”), in which the copies have a yellow background. If the digital image file is to be stored or forwarded, the digital image file could be viewed as a “full size” image with a yellow background, rather than as a relatively small region of yellow surround by a white border.

A variant to the third embodiment could include an alternative feature associated with detecting the dominant color of the original 50. In this case, there is no filling of a background color as recited in step S36. Instead, if a scanned region is much larger than an original 50, detecting the color of the original 50 can be used to detect the edges of the original 50. The digital image file can therefore be reduced in size (e.g., “digitally cropped”) before storing, or before forwarding the digital image file to another device. In this variant, image data lying inside the scanned region but outside of the region of dominant color of the original 50 can be removed from the digital image file.

As an alternative to, or, as an additional feature to recognizing a background color in step S34, the processor 18 can recognize a background pattern of an original 50. The background pattern can be, for example, a texture of the medium of the original 50, such as is present in heavy, textured paper. Another example of a background pattern is ruled lines and/or a grid printed on an original 50. The processor 18 can recognize the presence of such patterns, and can fill in the background pattern as recited in step S36. Alternatively, the processor 18 can remove the background pattern from the digital image file. Both a background pattern and a background color can be recognized by the processor 18, and both or either of the background color and the background pattern can be used to fill in an original 50. Alternatively, both or either of the background color or background pattern can be removed from the digital image file.

In this specification, the term “cover” does not imply a device that is movable on a pivot, or any other specific structure. A cover as described in this specification instead indicates any structure, such as, for example, an opaque plate, capable as serving as a background for a scanning process. The term “image” indicates any color or black and white pattern, text, picture, or other visible image on an original.

While embodiments of imaging systems and methods of generating digital image files have been described with reference to the exemplary embodiments thereof, those skilled in the art will be able to make various modifications to the described embodiments of the invention without departing from the true spirit and scope of the invention. The terms and descriptions used herein are set forth by way of illustration only and are not meant as limitations.

In the claims:

1. An imaging system, comprising:
a platen;
an imager, the imager being disposed in the imaging system to detect an image of an original in a scanned region of the platen;
a cover, wherein an underside of the cover includes an identifiable pattern disposed over the platen; and
a processor, wherein the processor is capable of processing a scanned image of an original from the imager to generate a digital image file, and wherein the processor is capable of recognizing the identifiable pattern and removing data from regions of the digital image file including the identifiable pattern.

2. The imaging system of claim 1, comprising:
rollers disposed in the system to advance originals through the system, wherein the rollers include the identifiable pattern.

3. The imaging system of claim 1, comprising:
a controller, wherein the controller controls scanning by the imager.

4. The imaging system of claim 1, wherein the processor uses a pattern matching algorithm to recognize the identifiable pattern.

5. A method of generating a digital image file, comprising:
scanning an image of a scanned region while an original is located in the scanned region;
generating a digital image file from the scan;
detecting an identifiable pattern in the digital image file, wherein the identifiable pattern is adjacent to the original; and
removing image data from a portion of the digital image file including the identifiable pattern.

6. The method of claim 5, wherein the step of removing image data includes the step of:
executing a pattern matching algorithm, wherein the pattern matching algorithm compares a stored version of the identifiable pattern with the digital image file.

7. The method of claim 5, wherein the step of detecting an identifiable pattern comprises:
detecting an identifiable pattern located on at least one of an underside of a cover and a roller of an imaging system.

8. The method of claim 5, comprising:
storing the digital image file after removing the image data.

9. he method of claim 5, comprising:
producing a copy of the original using the digital image file.

10. An imaging system, comprising:
a platen;
an imager disposed in the imaging system to detect an image of an original in a scanned region of the platen;
a cover, wherein an underside of the cover is disposed over the platen; and
a processor, wherein the processor is capable of processing a digital image file from a scan of an original, and wherein the processor is capable of storing image data from a preliminary scan of the scanned region and comparing the image data from the preliminary scan with the digital image file and removing extraneous images from the digital image file based on the comparison.

11. The imaging system of claim 10, wherein the processor uses a pattern matching algorithm to compare image data from the preliminary scan with the digital image file.

12. A method of generating a digital image file, comprising:
performing one or more preliminary scans of a scanned region without an original present;
storing image data from the preliminary scan;
scanning the scanned region while an original is present in the scanned region;
generating a digital image file from the scan of the original; and
removing extraneous image data from the digital image file based on a comparison of the digital image file with the image data from the one or more preliminary scans.

13. The method of claim 12, wherein the step of removing image data comprises:
executing a pattern matching algorithm to match image data from the one or more preliminary scans with the digital image file.

14. The method of claim 12, wherein the step of performing one or more preliminary scans comprises:
performing periodic preliminary scans.

15. The method of claim 12, comprising:
generating a message indicating that maintenance or cleaning of an imaging system is required based on the preliminary scan.

16. A method of generating a digital image file, comprising:
scanning a scanned region while an original is located in the scanned region;
generating a digital image file from the scan;
detecting at least one of a background color and a background pattern of the original from the digital image file; and
filling in a region of the digital image file with at least one of the background color and background pattern.

17. The method of claim 16, wherein the step of detecting at least one of a background color and a background pattern comprises:
detecting at least one of a background color and a background pattern that comprises greater than a predetermined amount of an area of the scanned region.

18. The method of claim 16, wherein the step of detecting at least one of a background color and a background pattern comprises:
detecting at least one of a background color and a background pattern that comprises greater than a predetermined amount of an area of the original.

19. A method of generating a digital image file, comprising:
scanning a scanned region while an original is located in the scanned region;
generating a digital image file from the scan;
detecting at least one of a background color and a background pattern of the original from the digital image file; and
removing image data from the digital image file lying outside of a region of the digital image file having the at least one of a background color and a background pattern.

20. The method of claim 19, wherein the step of detecting at least one of a background color and a background pattern comprises:
detecting at least one of a background color and a background pattern that comprises greater than a predetermined amount of an area of the original.
